(19) United States
(12) Patent Application Publication
(10) Pub. No.: US 2016/0059282 A1
(43) Pub. Date: Mar. 3, 2016

(54) TREATMENT OF TAILINGS STREAMS

(71) Applicant: THE CHEMOURS COMPANY FC, LLC, Wilmington, DE (US)

(72) Inventor: Robert Harvey MOFFETT, Landenberg, PA (US)

(21) Appl. No.: 14/781,046

(22) PCT Filed: Apr. 1, 2014
(86) PCT No.: PCT/US14/32496

§ 371 Date: Sep. 29, 2015

Related U.S. Application Data
(60) Provisional application No. 61/808,852, filed on Apr. 5, 2013.

(51) Int. Cl. B09B 1/00; C02F 1/68; C02F 1/54; C02F 1/52; C02F 1/56

(52) U.S. Cl. CPC B09B 1/00; C02F 1/5236; C02F 1/56; C02F 1/545; C02F 1/68; C02F 2103/10

(57) ABSTRACT

This disclosure relates to a process for treating a tailings stream comprising water and solids. The process involves (a) contacting a gelling agent and an activator with the tailings stream, (b) entrapping the solids within a gel produced from the gelling agent, and (c) depositing the gel into a liquid. This disclosure also relates to a process for treating a tailings stream comprising water and solids beneath a liquid surface. The process involves (a) contacting a gelling agent and an activator with the tailings stream beneath the liquid surface, (b) entrapping the solids within a gel produced from the gelling agent.

### BACKGROUND

1. Field of the Disclosure

The present disclosure relates to a process for treatment of tailings streams.

2. Description of Related Art

Tailings, as a general term, refers to byproducts from mining operations and processing of mined materials in which a valuable material such as a metal, mineral, coal, and the like, is separated, for example, extracted, from a mined material, that is, material which has been removed from the earth. Tailings typically comprise one or more of clay, sand, and optionally rock. Tailings further comprise water. Water may be used in combination with mechanical and/or chemical processes for removing the valuable material from the mined material. Mining operations include those for precious metals, base metals, ores, clays and coal. In addition, mining operations include recovery of bitumen from oil sands. Essentially any mining or mineral processing operation that uses water to convey or wash materials will generate a tailings stream.

Tailings treatment and disposal are major issues for mining operations. Water recovery from the tailings for re-use in extraction processes and transportation is often desired. Tailings solids, such as clay, sand, and optionally rock and other solid materials are generally sent to a storage facility or disposal area local to the mining operation. Management of such storage facilities or disposal areas is an enormous task.

Storage or disposal of tailings involves construction of a facility that is safe for storage (including permanent storage), sufficiently large and stable to contain the tailings within the facility, and to protect the local environment. It may be desirable to access water from the tailings storage facility for use in mining operations such as extracting and other treatments.

Various tailings streams are produced in extraction processes. A tailings stream is an aqueous stream (slurry, suspension) containing components requiring further treatment, which may include extraction of valuable material or solids removal and/or purification to enable recycle of the water content of the tailings stream. Some tailings streams will be deposited in a tailings pond for long periods of time, including permanently. Coarse solids may settle quickly. The top layer of the pond may clarify with time to make water that is suitable for re-use in the extraction process. A layer may comprise water and fine solids, which solids settle very slowly. This layer may ultimately become mature fine tailings (MFT).

MFT is a stable composite slurry comprising one or more of clay, sand, silt, water and optionally rock. MFT has little strength, no vegetative potential and may be toxic to animal life, so it must be confined and prevented from contaminating water supplies. Typically, several years of settling time are required to make MFT, which may have little additional settling or consolidation occurring for decades.

Moffett disclosed, in US 2010/0104744 A1, a process to treat tailings streams with a silicate source and an activator. The silicate source is an alkali metal silicate, polysilicate microgel, or combinations thereof. The activator may be an acid, alkaline earth metal salt, aluminum salt, organic ester, dialdehyde, organic carbonate, organic phosphate, amide, or a combination thereof.

Alkali metal silicate solutions are distinct from colloidal silica sols by their ratio of silica to metal oxide (SiO₂:M₂O). For example, solutions of sodium silicate have SiO₂:Na₂O of less than 4:1, as disclosed by Iler, “The Chemistry of Silica”, Wiley Interscience (1979), page 116. Iler further recited that “silicate solutions of higher ratios were not available.”

Moffett disclosed in U.S. patent application Ser. No. 13/329,375, filed Dec. 19, 2011, a process to treat tailings streams with a gelling agent and an activator. The gelling agent is selected from the group consisting of colloidal silica, aluminum-modified colloidal silica, de-ionized colloidal silica, polysiloxane, siliconate, acrylamide, acrylate, urethane, phenoplast, aminoplast, vinyl ester-styrene, polyester-styrene, furfuryl alcohol-based furol polymer, epoxy, vulcanized oil, lignin, lignosulfonate, lignosulfite, montan wax, polyvinyl pyrrolidone, and combinations of two or more thereof. The activator can be any compound or mixture of compounds that will initiate gelation.

An important aspect of tailings management is consolidation of the tailings solids—that is, to produce a dense material containing the solids in the tailings, for example to minimize storage space required upon disposal.

While there have been many advances, there remains a need for a process to deposit treated tailings into existing water areas as well as in-situ treated of the tailings ponds in place. The present invention meets these needs.

### BRIEF SUMMARY OF THE DISCLOSURE

The present disclosure provides a process for treating a tailings stream comprising water and solids. The tailings treatment process comprises: (a) contacting a gelling agent and an activator with the tailings stream, (b) entrapping the solids within a gel produced from the gelling agent, and (c) depositing the gel into a liquid.

The present disclosure also provides a process for treating a tailings stream comprising water and solids beneath a liquid surface. The tailings treatment process comprises: (a) contacting a gelling agent and an activator with the tailings stream beneath the liquid surface, (b) entrapping the solids within a gel produced from the gelling agent.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

Before addressing details of embodiments described below, some terms are defined or clarified.

### Definitions

Certain terms as used herein have the definitions as provided below.

Clay is any naturally occurring material composed primarily of hydrous aluminum silicates. Clay may be a mixture of clay minerals and small amounts of nonclay materials or it may be predominantly one clay mineral. The type is determined by the predominant clay mineral.

The term coarse particle refers to a single particle or a collection of particles. It will be appreciated by those skilled in the art that that coarse particle size may vary depending on the source of the tailings stream. For example, in oil sands tailings coarse particles are defined as particles larger than 44 μm. Alternatively, in coal mine tailings, coarse particles are defined as particles larger than 2.5 μm.

Entrap solids means the solid particles, such as clay, sand, silt, and rock (if present), are trapped within the gel structure while the water is not permanently retained within the structure.

The term fine particle refers to a single particle or a collection of particles. It will be appreciated by those skilled in the art that that fine particle size may vary depending on the source of the tailings stream. For example, in oil sands tailings, fine particles are defined as particles smaller than 44 μm. Alternatively, in coal mine tailings, fine particles are defined as particles smaller than 2.5 μm.

Mineral is a naturally occurring inorganic element or compound having an orderly internal structure and characteristic chemical composition, crystal form, and physical properties.

Rock is any consolidated or coherent and relatively hard, naturally formed mass of mineral matter; stone, with the majority consisting of two or more minerals.

Sand is an unconsolidated or moderately consolidated sedimentary deposit, most commonly composed of quartz (silica), but may include particles of any mineral composition or mixture of rock or minerals, such as coral sand, which consists of limestone (calcium carbonate). (Source: AGI American Geosciences Institute)

Silt is a mixture of fine particulate rock and/or mineral.

The term “treated tailings” or “treated tailings stream”, as used herein, means the resulting tailings stream mixture after step (a). It comprises tailings stream, gelling agent, activator, formed gel, optionally reinforcing agent, and optionally accelerator.

The present disclosure provides a process for treating a tailings stream comprising, consisting essentially of, or consisting of water and solids. The tailings treatment process comprises: (a) contacting a gelling agent and an activator with the tailings stream, (b) entrapping the solids within a gel produced from the gelling agent, and (c) depositing the gel into a liquid.

The present disclosure also provides a process for treating a tailings stream comprising, consisting essentially of, or consisting of water and solids beneath a liquid surface. The tailings treatment process comprises: (a) contacting a gelling agent and an activator with the tailings stream beneath the liquid surface, (b) entrapping the solids within a gel produced from the gelling agent.

### Tailings Stream

Tailings stream is an aqueous fluid (slurry, suspension) comprising, consisting essentially of, or consisting of water and solids. In some embodiments of this invention, the tailings stream comprises, consists essentially of, or consists of water, solids, and polyacrylamide. In some embodiments of this invention, the polyacrylamide is from a tailings treatment process. For example, fresh tailings can be thickened with a polyacrylamide. In some embodiments of this invention, the tailings stream comprises, consists essentially of, or consists of water, solids, and polysilicate microgel. In some embodiments of this invention, the polysilicate microgel is from the oil sands bitumen recovery process. In some embodiments of this invention, the tailings stream comprises, consists essentially of, or consists of water, solids, polyacrylamide, and polysilicate microgel.

In some embodiments of this invention, the tailings stream solids comprise clay, sand, rock, silt, or any combinations thereof. Solids may further comprise unextracted particles of mineral in the mined material. A portion or all of the solids in the tailings stream may be suspended in the water. The suspended solids are typically not easy to be separated from the water.

The solids have a particle size typically less than 0.5 mm, and in some embodiments less than 0.05 mm. The tailings stream typically comprises at least 5% by weight solids, in some embodiments greater than 10%, and in some other embodiments greater than 20% by weight solids, based on the total weight of the tailings stream. The rest parts of the tailings stream are typically water and/or dissolved materials such as salts and processing aids (e.g., organic solvent, extraction aids such as polysilicate microgel, and polyacrylamide). The tailings stream may comprise less than 70% solids, or less than 50% solids, or less than 40% solids, based on the total weight of the tailings.

For a particular application, oil sands tailings streams may comprise solids wherein 10% to 100% by volume of the solids have a particle size of less than 0.5 mm, in some embodiments, 20% by volume to 100% by volume of the solids have a particle size less than 0.5 mm, based on the total volume of the solids. In some embodiments of this invention, oil sands tailings streams may comprise solids wherein 5% to 100% by volume of the solids have a particle size of less than 0.05 mm, and in some embodiments, 20% by volume to 100% by volume of the solids have a particle size less than 0.05 mm, based on the total volume of the solids.

Tailings stream solids from mining and mineral processing operations have varied size distributions. Most tailings stream solids comprise a high percent of fine particles. For example, most tailings stream solids produced from mining and processing of copper, gold, iron, lead, zinc, molybdenum and taconite have 50% by weight or more of the particles passing a 0.075 mm (No. 200) sieve. Tailings stream solids from iron ore mining and mineral processing may have a slighter larger particle size. For properties of a number of tailings, see, for example http://www.rmrc.unh.edu/tools/uguidelines/mwstl.asp, accessed Jun. 21, 2012.

The tailings stream is typically produced from a mining operation or mineral processing plant. In some embodiments of this invention, the tailings stream is produced in a process to extract bitumen from oil sands ores. In a mining operation a material is removed from the earth. In a mineral processing plant, such material is treated to extract a valuable mineral such as coal, oil (such as from oil sands), precious metal ore, base metal ore, clay, gemstone. Mined materials include, for example, coal, uranium, potash, clay, phosphate, gypsum, precious metals and base metals. The generated tailings stream may comprise valuable mineral content (e.g., bitumen, coal, precious or base metal, gemstone) as part of the solids. Thus, there may be steps in advance of entrapping the solids (herein, step (a)) to remove the valuable mineral content. Essentially any mining or mineral processing operation that uses water to convey or wash materials will generate a tailings stream.

In a mining operation, there may be interest to recover and recycle the water content of the tailings stream. Alternatively, in an industrial mineral processing operation, water may be recycled to the processing operation such as milling, refining, smelting, and other manufacturing processes. Refining operations, for example, include extraction of oil, nickel or copper from the mined material.

Precious metals include gold, silver, platinum, palladium, ruthenium, rhodium, osmium, iridium. Gold, silver, platinum, and palladium are the most commonly mined precious metals. Base metals include nickel, copper, aluminum, lead, zinc, tin, tungsten, molybdenum, tantalum, cobalt, cadmium, titanium, zirconium, antimony, manganese, beryllium, chromium, germanium, vanadium, gallium, hafnium, indium, niobium, rhenium and thallium. Nickel, copper, aluminum, lead, and zinc are the most commonly mined base metals. Gemstones include diamond, emeralds (beryl), rubies, garnet, jade, opal, peridot, sapphire, topaz, turquoise, and others.

Other mining and mineral processing operations include oil sands mining and bitumen extraction and recovery processes.

The tailings stream may be a tailings pond, ore or ore mining process waters, chemically thickened tailings, fresh tailings, MFT, consolidated composite tailings (CCT), or a combination thereof. CCT may be referred to as composite tailings (CT) and non-segregating tailings (NST). Tailings streams useful in the present invention are also described in U.S. patent application Ser. No. 13/329,375.

### Gelling Agent

The process of this invention uses a gelling agent. Gelling agents are compounds that facilitate gel formation of the tailings streams. Gelling agents are water soluble or capable of being dispersed in water.

Suitable gelling agent of the present disclosure is selected from the group consisting of alkali metal silicates, polysilicate microgels, deionized silicate solutions having a molar ratio of Si:M of at least 2.6, wherein M is an alkali metal, colloidal silica, aluminum-modified colloidal silica, de-ionized colloidal silica, polysiloxane, siliconate, acrylamide, acrylate, polyol, phenoplast, aminoplast, vinyl ester-styrene, polyester-styrene, furfuryl alcohol-based furol polymer, epoxy, vulcanized oil, lignin, lignosulfonate, lignosulfite, montan wax, polyvinyl pyrrolidone, and combinations of two or more thereof.

In some embodiments of this invention, the gelling agent comprises, consists essentially of, or consists of an alkali metal silicate. In some embodiments of this invention, the gelling agent comprises, consists essentially of, or consists of a polysilicate microgel. In some embodiments of this invention, the gelling agent comprises, consists essentially of, or consists of an acrylamide. In some embodiments of this invention, the gelling agent comprises, consists essentially of, or consists of a deionized silicate solution having a molar ratio of Si:M of at least 2.6, wherein M is an alkali metal.

In some embodiments of this invention, the gelling agent is selected from the group consisting of colloidal silica, aluminum-modified colloidal silica, deionized colloidal silica, and combinations thereof.

### Polysilicate Microgel

Polysilicate microgels are aqueous solutions which are formed by the partial gelation of an alkali metal silicate or a polysilicate, such as sodium polysilicate. The microgels, which can be referred to as “active” silica, in contrast to commercial colloidal silica, comprise solutions of from 1 to 2 nm diameter linked silica particles which typically have a surface area of at least about 750 m²/g. Polysilicate microgels are commercially available from E. I. du Pont de Nemours and Company, Wilmington, Del.

Polysilicate microgels have SiO₂:Na₂O mole ratios of 4:1 to about 25:1, and are discussed on pages 174-176 and 225-234 of “The Chemistry of Silica” by Ralph K. Iler, published by John Wiley and Sons, N.Y., 1979. General methods for preparing polysilicate microgels are described in U.S. Pat. No. 4,954,220, the teachings of which are incorporated herein by reference.

Polysilicate microgels include microgels that have been modified by the incorporation of alumina into their structure. Such alumina-modified polysilicate microgels are referred as polyaluminosilicate microgels and are readily produced by a modification of the basic method for polysilicate microgels. General methods for preparing polyaluminosilicate microgels are described in U.S. Pat. No. 4,927,498, the teachings of which are incorporated herein by reference.

Polysilicic acid is a form of a polysilicate microgel and generally refers to those silicic acids that have been formed and partially polymerized in the pH range 1-4 and comprise silica particles generally smaller than 4 nm diameter, which thereafter polymerize into chains and three-dimensional networks. Polysilicic acid can be prepared, for example, in accordance with the methods disclosed in U.S. Pat. No. 5,127,994, incorporated herein by reference.

In addition to the above-described polysilicate microgels, the term “polysilicate microgels” as used herein, includes silica sols having a low S value, such as an S value of less than 50%. “Low S-value silica sols” are described in European patents EP 491879 and EP 502089. EP 491879 describes a silica sol having an S value in the range of 8 to 45% wherein the silica particles have a specific surface area of 750 to 1000 m²/g, which have been surface modified with 2 to 25% alumina. EP 502089 describes a silica sol having a molar ratio of SiO₂ to M₂O, wherein M is an alkali metal ion and/or an ammonium ion of 6:1 to 12:1 and containing silica particles having a specific surface area of 700 to 1200 m²/g.

Deionized Silicate solution

A deionized silicate solution may be prepared by means known in the art, for example, by an electrolytic process and/or by use of an ion exchange resin. Ion exchange methods are disclosed, for example, by Bird, in U.S. Pat. No. 2,244,325. The deionized silicate solution may be prepared by contacting a solution of alkali metal silicate with a strong cation exchange resin. The deionized silicate solution may alternatively be prepared by contacting a solution of alkali metal silicate with a weak ion exchange resin.

Iler, in U.S. Pat. No. 3,668,088, discloses a process to remove sodium anions from sodium silicate in an electrodialysis process wherein sodium silicate aqueous solution is electrolyzed while separated from an acid anolyte by a cation-permeable, anion-impermeable membrane.

A deionized silicate solution may be prepared by removing alkali metal from a solution of alkali metal silicate using bipolar electrolysis.

Other processes to prepare deionized silicate solutions include processes which rely on a combination of electrolysis and ion exchange membranes or ion-permeable membranes have been disclosed, for example, in JP2003236345A, JP2004323326A, JP07000803A, JP2002220220A, JP2003311130A and JP2002079527A.

More specifically, a sodium silicate (or water glass) solution may be contacted with a strong cation exchange resin. Strong cation exchange resins have sulfonic acid functionality, R—SO₃H, wherein R is the backbone of the resin or the matrix. The resin or matrix can be, for example, functionalized styrene divinylbenzene copolymers. Strong cation exchange resins are commercially available, for example, from Dow Chemical Company.

The deionized silicate solutions may be modified by alumina before or during or after the deionization process. Processes such as those disclosed in U.S. Pat. Nos. 5,482,693; 5,470,435; 5,543,014; and 5,626,721 can be used. Care must be taken when the process uses sodium aluminate so that the added sodium does not provide a Si:Na molar ratio less than 2.6 after such treatment.

The deionized silicate solution may be stabilized by methods known in the art, such as by control of pH or temperature.

A deionized silicate solution is an aqueous (water-based) solution. The solution has a molar ratio of Si:M of at least 2.6. M is an alkali metal, such as lithium, sodium, potassium, or combinations thereof. Preferably the molar ratio is 4 or greater, more preferably 5 or greater. The upper limit of Si:M molar ratio may be set by practical considerations, for example capacity of an ion exchange resin for a given quantity of silicate solution, or alternatively, a minimum threshold for sodium in a particular tailings treatment system, in particular when recovered water is recycled for re-use.

The concentration of silica in the solution after deionization is 1-15% by weight, as “SiO₂”, preferably 2-10%, more preferably 4-7%.

The deionized silicate solution may comprise particles, anions, and oligomers of silica. The silica specific surface area is greater than 500 m²/g, typically greater than 750 m²/g.

### Activator

Activators useful in the present disclosure comprise any compound or mixture of compounds that can initiate gelation of the gelling agent. In some embodiments of this invention, the activator is selected from the group consisting of carbon dioxide, acids, bases, alkaline earth metal salts, aluminum salts, organic esters, aldehydes, dialdehydes, organic carbonates, organic phosphates, amides, peroxides, isocyanate, sodium aluminate, aluminum sulfate, and combinations thereof. In some embodiments of this invention, the activator is carbon dioxide or sulfuric acid.

Examples of acids useful as activators may be selected from the group consisting of sulfuric acid, phosphoric acid, sodium phosphate, sodium bicarbonate, hydrochloric acid, sodium hydrogen sulfate, oxalic acid, boric acid, citric acid, lactic acid, tartaric acid, and acetic acid. Examples of alkaline earth metal salts and aluminum salts may be selected from the group consisting of calcium chloride, calcium oxide, calcium carbonate, calcium sulfate, magnesium sulfate, magnesium chloride, and aluminum sulfate. Examples of organic esters, aldehydes, dialdehydes, organic carbonates, organic phosphates, and amides may be selected from the group consisting of acetic esters of glycerol, glyoxal, ethylene carbonate, propylene carbonate, formaldehyde and formamide. Examples of bases may be selected from the group consisting of aniline, triethanolamine, sodium hydroxide, potassium hydroxide, lime, barium hydroxide, and ammonia. One or more activators may be used.

According to the present disclosure, certain activators are preferably selected to initiate gelling of a specific gelling agent. In some embodiments of this invention, the gelling agent comprises, consists essentially of, or consists of colloidal silica, aluminum modified colloidal silica, or their combination, and the activator is selected from the group consisting of carbon dioxide, acids, salts of multivalent cations, organic esters, dialdehydes, organic carbonates, organic phosphates, amides, and combinations of two or more thereof.

In some embodiments of this invention, the gelling agent comprises, consists essentially of, or consists of alkali metal silicates, polysilicate microgels, deionized silicate solutions having a molar ratio of Si:M of at least 2.6, wherein M is an alkali metal, or their combination, and the activator is selected from the group consisting of acids, alkaline earth metal salts, aluminum salts, organic esters, dialdehydes, organic carbonates, organic phosphates, amides, carbon dioxide, sodium aluminate, and combinations thereof.

In some embodiments of this invention, the gelling agent comprises, consists essentially of, or consists of an alkali metal silicate, and the activator is selected from the group consisting of acids, alkaline earth metal salts, aluminum salts, organic esters, dialdehydes, organic carbonates, organic phosphates, amides, carbon dioxide, sodium aluminate, and combinations thereof. In some embodiments of this invention, the gelling agent comprises, consists essentially of, or consists of an alkali metal silicate, and the activator is carbon dioxide or an acid such as sulfuric acid.

In some embodiments of this invention, the gelling agent comprises, consists essentially of, or consists of polysiloxane, siliconate, or their combination, and the activator is an acid or a base.

In some embodiments of this invention, the gelling agent comprises an acrylamide, and the activator comprises an inorganic peroxide such as ammonium persulfate.

In some embodiments of this invention, the gelling agent comprises an acrylate, and the activator comprises a sulfate such as sodium thiosulfate and potassium persulfate in triethanolamine.

In some embodiments of this invention, the gelling agent comprises, consists essentially of, or consists of a polyol, and the activator comprises, consists essentially of, or consists of an isocyanate (di- and/or poly-isocyanate).

In some embodiments of this invention, the gelling agent comprises, consists essentially of, or consists of a phenoplast, and the activator comprises, consists essentially of, or consists of an acid or a base.

In some embodiments of this invention, the gelling agent comprises, consists essentially of, or consists of an aminoplast, and the activator comprises, consists essentially of, or consists of an acid or an ammonium salt. Examples of ammonium salts include ammonium chloride, ammonium sulfate, and ammonium persulfate.

In some embodiments of this invention, the gelling agent comprises, consists essentially of, or consists of a vinyl ester styrene or a polyester styrene, and the activator comprises, consists essentially of, or consists of a peroxide. Examples of peroxides include benzoyl peroxide and methyl ketone peroxide.

For furols, polyvinylpyrrolidone, and for the reaction of calcium lignin sulfates and hexavalent chromium to form lignin sulfonates, acids are the preferred activators. For epoxy resins, preferred activators include bases, such as a polyamine. For lignins, preferred activators include formaldehyde, sodium or potassium bichromate, ferric chloride, sulfuric acid, aluminum sulfate, aluminum chloride, ammonium persulfate, and copper sulfate.

### Accelerators

The process of this disclosure optionally uses an accelerator. Accelerators are useful to increase speed and decrease the time for the solids to become immobile. Accelerating agents are particularly useful for environments where temperatures are below 40° F. (4.4° C.). Examples of accelerators include multivalent metal compounds, and oxidizers such as persulfates. The multivalent metals may be calcium, magnesium, aluminum, iron, titanium, zirconium, cobalt or a combination of two or more thereof. Preferably, the multivalent metal compound is soluble in water and is used as an aqueous solution. Preferred multivalent metal compounds may be selected from the group consisting of calcium chloride, calcium sulfate, calcium hydroxide, aluminum sulfate, magnesium sulfate, aluminum chloride, polyaluminum chloride, polyaluminum sulfate, and aluminum chlorohydrate. More preferably the multivalent metal compound is calcium sulfate, aluminum sulfate, polyaluminum sulfate, polyaluminum chloride, aluminum chlorohydrate, cobalt naphthenate, or combinations thereof. Examples of persulfates include sodium persulfate, and potassium persulfate. Accelerators particularly useful for acrylamindes include nitrilo and amino propionamides, such as nitrilotrispropionamide (NTP), β-dimethylaminopropionamide (DAP), diethylaminopropionamide (REAPN), or dimethylaminopropionamide (DMAPN). Accelerators particularly useful for polyol include water and amines.

According to the present disclosure, the accelerator is preferably selected based on compatibility of the gelling agent used. For polyester styrene, a preferred accelerator is cobalt naphthenate.

### Reinforcing Agents

The process of this disclosure optionally uses a reinforcing agent. Reinforcing agents are compounds that act as fillers and mechanically strengthen the treated tailings stream. Reinforcing agents can be used in an amount up to about 70 weight percent of the total weight of the trafficable deposit.

Reinforcing agents are selected from the group consisting of gravel, sand from mining operations, waste rock from mining operations; petroleum coke, coal particles; elemental crystalline sulfur; inorganic fibers; organic fibers, and combinations of two or more thereof. Inorganic fibers can be, for example, steel fibers or fiberglass. Organic fibers can be, for example, pulp waste, paper waste, wood waste, and waste paper.

In addition, the surface of the reinforcing agent may be untreated or the surface may have been treated with a surface-active agent. A typical surface-active agent is an organic silane. Surface-active agents strengthen interfacial bonds between the reinforcing agent and the treated tailings.

### Treatment of Tailings Stream

The tailings stream can be any tailings stream such as, for example, those described hereinabove. A preferred tailings stream is produced in a bitumen extraction process. In some embodiments of this invention, the tailings stream comprises, consists essentially of, or consists of mature fine tailings. In some embodiments of this invention, the tailings stream comprises, consists essentially of, or consists of fresh tailings. In some embodiments of this invention, the tailings stream is chemically thickened, mechanically thickened, or both, forming a partially dewatered tailings stream, prior to step (a). In some embodiments of this invention, the chemically thickening is by flocculation. In some embodiments of this invention, the mechanically thickening is by centrifuge. In some embodiments of this invention, a tailings stream is treated with a flocculant prior to centrifuge.

The present disclosure provides a process for treating a tailings stream comprising, consisting essentially of, or consisting of water and solids. The tailings treatment process comprises: (a) contacting a gelling agent and an activator with the tailings stream, (b) entrapping the solids within a gel produced from the gelling agent, and (c) depositing the gel into a liquid.

Step (c) can be accomplished by depositing of the gel into the liquid from above the top layer of the liquid or sub-surface to the liquid. The present disclosure provides the ability to store treated tailings under water, while keeping the above layer of water clean and un-polluted from tailings streams.

In some embodiments of this invention, the gel can be partially gelled or fully gelled prior to step (c). In some embodiments of this invention, the gel can be allowed to strengthen and solidify prior to step (c). The gel can be un-dried, partially dried or fully dried prior to step (c). The process as described herein can be done in-situ in a tailings pond. Optionally the process of the present disclosure further comprises adding an accelerator and/or a reinforcing agent in the contacting step (a). In some embodiments of this invention, the tailings treatment process further comprises contacting a reinforcing agent with the tailings stream in step (a). In some embodiments of this invention, the tailings treatment process further comprises contacting an accelerator with the tailings stream in step (a).

It is noted herein that in contrast to flocculation, in which suspended particles coalesce to form a precipitate, in the process of this disclosure, upon contact with the gelling agent and activator, the tailings stream becomes viscous, and then develops rigidity as it strengthens and solidifies in the form of a gel.

Each gelling agent, activator, and optional accelerator and optional reinforcing agent is described above. Each of these is used in an effective amount to produce a gel, entrapping solids, such as sand, clay, silt, and other solids in the stream, and to provide a gel. Thus, the solids from the tailings stream, and optional reinforcing agent are entrapped within the gel.

When used, a reinforcing agent is added in an amount equal to 0.1 to 700 kg/tonne based on the total weight of the tailings stream. Preferably the reinforcing agent is added in an amount equal to 0.1 to 100 kg/tonne based on the total weight of the tailings stream. More preferably the reinforcing agent is added in an amount equal to 0.1 to 10 kg/tonne based on the total weight of the tailings stream.

The contacting step (a) can be performed in various ways. The tailings stream, gelling agent, and activator with optional reinforcing agent and optional accelerator may be contacted in a vessel, in a mature fine tailings pond, or in a pipeline transporting the tailings stream to a potential deposition site. The tailings stream, gelling agent, activator and optional accelerator and/or reinforcing agent may be contacted and centrifuged to enhance separation with a reduced amount of gelling agent needed.

In some embodiments of this invention, the gelling agent and the activator are added into or contacted with a tailings stream simultaneously or near-simultaneously.

In some embodiments of this invention, the gelling agent and the activator are added into or contacted with the tailings stream not at the same time. Instead, the activator addition is delayed by a pre-determined period of time. As a result, the gel formation is delayed. The delaying of the gel formation allows for the treated tailings stream to flow longer, for example, in a transfer pipeline. This is important for when the treated tailings need to flow over a longer distance prior to gelling. The pre-determined period of time can be at least 1 minute, 2 minutes, 5 minutes, 10 minutes, 15 minutes, 20 minutes, 25 minutes, or 30 minutes. Typically, the pre-determined period of time is no longer than 1440 minutes

The gel formed in step (b) may be allowed to strengthen and solidify prior to step (c). By “strengthen and solidify”, it is meant herein that the gel has formed a solid mass, which separates from the water present in the tailings stream. In the step of allowing the gel to strengthen and solidify, the gel may be partially or fully dewatered and/or dried. In some embodiments of this invention, the gel can be allowed to dewater partially or fully prior to step (c).

Dewatering includes partial dewatering and complete dewatering. In some embodiments of this invention, the dewatering occurs by air drying (evaporation), water run-off, compression, syneresis, exudation, freeze/thaw, sublimation, or any combination thereof. In some embodiments, the dewatering occurs by evaporation. In some embodiments, the dewatering occurs by water run-off. In some embodiments, the water run-off is recovered and recycled.

By “run-off” it is meant that water is exuded from the gel-entrapped solids, or alternatively water from natural precipitation (rain, snow) that passes over the gel-entrapped solids and runs off the tailings. Run-off is generally captured in a water collection area (e.g., a pond). If water run-off occurs, one may recover the water from this process and recycle the run-off water. For compression, the solids can be deposited into a dewatering pit, where one or more sides allow water run-off to be recovered. For example, the water run-off or recovered water can be re-used in the bitumen extraction.

The gel may also be mechanically dewatered and/or partially dried, for example, but not limited to, by use of a press used to increase solids concentration prior to step (c).

In some embodiments of this invention, the tailings treatment process further comprises depositing a layer of sand or other solids to the top of the deposited gel. The tailings treatment process can then be repeated numerous times to create a multi layers of alternating gel, sand or other solids, gel, sand or other solids, gel, etc. Layering the gel and sand or other solids provides an additional benefit of exuding excess water from the gel and thus consolidating the gel layers to a smaller volume.

In some embodiments of this invention, the tailings treatment process further comprises removing the deposited gel from the liquid and allowing the gel to partially or fully dewater. The dewatering can occur by processes described herein above. The dewatered gel may still contain some water or may be fully dried. The dewatered gel can be useful as a trafficable deposit. Preferably, the trafficable deposit will have shear stress greater than untreated tailings streams. Preferably the trafficable deposit has a minimum undrained shear strength of 5 kPa. A trafficable deposit may be produced according to this disclosure by processes described herein above.

The present disclosure also provides a process for treating a tailings stream comprising, consisting essentially of, or consisting of water and solids beneath a liquid surface. The tailings treatment process comprises: (a) contacting a gelling agent and an activator with the tailings stream beneath the liquid surface, (b) entrapping the solids within a gel produced from the gelling agent.

This process allows the treatment of the tailings ponds in-situ and without the need to extract the tailings stream from the pond. Gelling agents, activators, tailings streams are as defined above.

In some embodiments of this invention, the tailings treatment process beneath the liquid surface further comprises contacting a reinforcing agent, an accelerator, or any of their combinations with the tailings stream in step (a). Reinforcing agents and accelerators are as defined above.

In some embodiments of this invention, the tailings treatment process beneath the liquid surface further comprises depositing a layer of sand or other solids to the top of the gel.

In some embodiments of this invention, the tailings treatment process beneath the liquid surface further comprises removing the gel from the liquid and allowing the gel to partially or fully dewater. The dewatering can occur by processes described herein above.

Many aspects and embodiments have been described above and are merely exemplary and not limiting. After reading this specification, skilled artisans appreciate that other aspects and embodiments are possible without departing from the scope of the invention.

### EXAMPLES

The concepts described herein will be further described in the following examples, which do not limit the scope of the invention described in the claims.

### Examples 1 to 3

Examples 1 to 3 demonstrate the effect of treating tailings using sodium silicate and carbon dioxide, allowing it to gel, then deposited it into a liquid. These examples demonstrate that the treated tailings do not disperse back into water and provides the ability to store these treated tailings underwater without creating a re-dispersal of the solids.

Samples of mature fine tailings (30.41% solids), from an Alberta Oil sands producer, were treated with various dosages sodium silicate solution (3.22 ratio, see Table 1 below). The pH of the samples were lowered to 7 by addition of gaseous carbon dioxide (activator). The treated tailings were then individually poured into 3 separate 3″ diameter by 5″ high PVC pipe sections (with one closed end) and then capped. The treated tailings were then stored for 3 days in the sealed pipe to allow for complete gel formation. After 3 days, the examples were removed from the pipes and placed into a plastic pail and completely submerged in deionized water (7515 grams). After 10 days the samples were removed from the water. The water was then measured for suspended solids content and reported in Table 1 as Suspended Solid Concentration. Also in Table 1 is the Suspended Solids Concentration Relative to Complete Re-dispersion. This value is a calculation based on the amount of measured suspended solids for each example and compared to a complete re-dispersion of the solids back into the water. A value of 100% indicates full re-dispersion of the solids into the water. A value of 0% indicates that none of the solids were re-dispersed into the water. Lower values for Suspended Solids Concentration Relative to Complete Re-dispersion are desired.

TABLE 1
Silicate concentration, suspended solids, and suspended solids relative to
complete re-dispersion.

| | Wt % SiO2 added | Suspended | Suspended Solids Conc |
|---|---|---|---|
| | relative to water in | Solid Conc | Relative to Complete Re- |
| Example | MFT | (wt %) | dispersion |
| 1 | 0.5 | 0.34 | 12.83% |
| 2 | 0.75 | 0.12 | 4.47% |
| 3 | 1.0 | 0.12 | 4.44% |

As can be seen in Table 1, at 0.5% SiO2 concentration for treating tailings streams using carbon dioxide, when gelled, only results in a 12.83% suspended solids re-dispersed into water. As the SiO2 concentrations increase to 0.75 and 1%, the suspended solids relative to complete re-dispersion decreased to 4.47% and 4.44%, respectively.

### Examples 4 to 7

Examples 4 to 7 illustrate the effect of using sulfuric acid as the activator in place of carbon dioxide.

Samples of mature fine tailings (30.49% solids), from an Alberta Oil sands producer, were treated with various dosages sodium silicate solution (3.22 ratio, see table 1 below). The pH of the samples was lowered to 7 by addition sulfuric acid (activator). The treated tailings were then individually poured into 3 separate 3″ diameter by 5″ high PVC pipe sections (with one closed end) and then capped. The treated tailings were then stored for 3 days in the sealed pipe to allow for complete gel formation. After 3 days, the examples were removed from the pipes and placed into a plastic pail and completely submerged in deionized water (7515 grams). After 10 days the samples were removed from the water. The water was then measured for suspended solids content and reported in Table 2 as Suspended Solid Concentration. Also in Table 2 is the Suspended Solids Concentration Relative to Complete Re-dispersion. This value is a calculation based on the amount of measured suspended solids for each example and compared to a complete re-dispersion of the solids back into the water. A value of 100% indicates full re-dispersion of the solids into the water. A value of 0% indicates that none of the solids were re-dispersed into the water. Lower values for Suspended Solids Concentration Relative to Complete Re-dispersion are desired.

TABLE 2
Silicate concentration, suspended solids, and suspended solids relative to
complete re-dispersion.

| | Wt % SiO2 added | Suspended | Suspended Solids Conc |
|---|---|---|---|
| | relative to water | Solid | Relative to Complete Re- |
| Example | in MFT | Conc (wt %) | dispersion of MFT |
| 4 | 0.25 | 0.61 | 27.50% |
| 5 | 0.50 | 0.40 | 18.27% |
| 6 | 0.75 | 0.19 | 7.85% |
| 7 | 1.00 | 0.09 | 4.29% |

As can be seen in Table 2, at 0.25% SiO2 concentration for treating tailings streams using sulfuric acid, when gelled, only results in a 27.50% suspended solids re-dispersed into water. As the SiO2 concentrations increase to 0.50, 0.75 and 1%, the suspended solids relative to complete re-dispersion decreased to 18.27%, 7.85% and 4.29%, respectively.

### Example 8

This example demonstrates how mature fine tailings treated with sodium silicate and acid, then partially dewatered remain essentially unaffected if the treated tailings are submerged in water.

Mature fine tailings (MFT) from an oil sands mine in Alberta, Canada were obtained. The starting MFT had a solids content of 36.7 wt %. The solids in the MFT were composed primarily of clays and silt. MFT samples were treated with various dosages of 3.2 ratio sodium silicate as shown in Table 3. Enough sulfuric acid was added to the samples to achieve pH 7. After treatment, the samples were partially dewatered to the solids content shown in Table 3. A solid column of each treated and partially dewatered MFT sample was pushed into the bottom of a 1 liter graduated laboratory cylinder and then covered with process water also obtained from an Alberta oil sands producer. The heights of the partially dewatered MFT samples were monitored with time. As can be seen in Table 3 there is only minimal change in the heights of the MFT samples after 120 days demonstrating the treated samples will not redisperse into MFT when submerged.

TABLE 3

| | Starting | Starting | Volume of | Change in Vol |
|---|---|---|---|---|
| | Treated MFT | Volume of | Treated MFT in | of Treated |
| SiO₂/Tailings | Solids Conc. | Treated MFT in | Cylinder after | MFT after |
| Water ratio | (wt %) | Cylinder (mls) | 120 Days (mls) | 120 Days (mls) |
| Untreated | 74.0 | 122 | 159 | 37 |
| 1/800 | 71.4 | 130 | 159 | 29 |
| 1/400 | 67.9 | 154 | 170 | 16 |
| 1/200 | 65.4 | 155 | 171 | 16 |
| 1/133 | 63.3 | 155 | 169 | 14 |

After 190 days the yield stress of the treated tailings were measured using a Brookfield rheometer equipped with a vane spindle rotating at 0.1 rpm and compared to the yield stress of the samples before being submerged. As can be seen in Table 4 the treated MFT retained significant yield stress compared to untreated MFT.

TABLE 4

| SiO₂/ | Yield | Yield | Strength @ |
|---|---|---|---|
| Tailings | Stress (kPa) | Stress (kPa) | 190 Days/ |
| Water | before | after 190 days | Initial |
| ratio | Submersion | Submersion | Strength |
| Untreated | 45.3 | 6.2 | 13.7% |
| 1/800 | 49.6 | 12.9 | 26.0% |
| 1/400 | 61.2 | 24.0 | 39.2% |
| 1/200 | 68.3 | 59.1 | 86.5% |
| 1/133 | 78.2 | 80.2 | 103% |

### Example 9

This example demonstrates how mature fines tailings can be treated with a combination of sodium silicate and sodium aluminate solution and then remain stable after being submerged under water.

Mature fine tailings (MFT) from an oil sands mine in Alberta, Canada were obtained. The starting MFT had a solids content of 36.7 wt %. The solids in the MFT were composed primarily of clays and silt. 200 grams of MFT was treated by addition of 6.32 grams of a 13 wt % sodium aluminate solution followed by 2.22 grams of 3.2 ratio sodium silicate solution. The treated tailings were placed into the barrel of a 60 ml plastic syringe which had its tip removed so as to create a full bore opening. Two days after treatment the tailings were ejected from the syringe as an upright column in a glass jar. The jar was then filled with 340.8 grams of process water obtained from an Alberta oil sands producer. The water surrounded the treated MFT column on the sides and covered its top end. After 62 days of being submerged, the treated MFT column is still upright and shows no sign of redispersion back to MFT.

### Example 10

This example demonstrates how mature fine tailings can be treated with a combination of sodium silicate solution and sulfuric acid and the resulting partially gelled tailings resisted re-dispersion when poured into water.

Mature fine tailings (MFT) were obtained from an oil sands mine in Alberta, Canada. The MFT had a starting solids concentration of 39.9 wt %. The MFT was treated in a 20 liter pail by admixing 0.53 g of 3.2 ratio sodium silicate solution per 100 g MFT followed by enough sulfuric acid to achieve approximately pH 7. The mixture was mixed for 3 minutes at 600 rpm. After 3 minutes the mixer speed was reduced to 300 rpm and a ½″ diameter ball valve located at the base of the pail was partially opened allowing the treated MFT to flow into a 122 cm long acrylic flume partially filled with water. The end of the flume where the MFT entered was raised 17.8 cm to create an angle of 8.3°. The treated MFT flowed approximately 28 cm before encountering the water in the flume. Approximately 5 liters of treated MFT was discharged into the flume over a 342 second period. The treated MFT was observed to flow into the water without dispersion.

### Example 11

Example 10 was repeated under different conditions.

MFT having a starting solids concentration of 39.9 wt % was treated in a 20 liter pail by admixing 0.74 g of 3.2 ratio sodium silicate solution per 100 g MFT followed by enough sulfuric acid to achieve approximately pH 7. The mixture was mixed for 30 seconds at 600 rpm. After 30 seconds the mixer speed was reduced to 300 rpm and a½″ diameter ball valve located at the base of the pail was fully opened allowing the treated MFT to flow into a 122 cm long acrylic flume partially filled with water. The end of the flume where the MFT entered was raised 17.8 cm to create an angle of 8.3°. The treated MFT flowed approximately 25 cm before encountering the water in the flume. Approximately 5 liters of treated MFT was discharged into the flume over a 60 second period. The treated MFT was observed to flow into the water without dispersion.

### Example 12

This example demonstrates how mature fine tailings can be treated by in-situ polymerization of an acrylamide solution

Mature fine tailings (MFT) were obtained from an oil sands mine in Alberta, Canada. The MFT had a starting solids concentration of 30.9 wt %. 250 grams of MFT was treated by addition of an ammonium persulfate solution (0.6 grams of ammonium persulfate dissolved in 20 ml of water), followed by addition of 0.45 grams of triethanolamine, and then 10 ml of Floset 100 (available from SNF Floerger). The treated tailings were poured into a 250 ml beaker and covered. After 4 days the yield stress of the treated tailings was determined to be 539 Pa. The treated tailings were then removed from the 250 ml beaker and placed into a 1000 ml beaker and covered with process water obtained from an Alberta oil sands producer. Four days after being covered with process water the treated tailings show no visual sign of dissolution or re-dispersion.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

What is claimed is:

1. A process for treating a tailings stream comprising water and solids, comprising: (a) contacting a gelling agent and an activator with the tailings stream, (b) entrapping the solids within a gel produced from the gelling agent, and (c) depositing the gel into a liquid.

2. A process according to claim 1, further comprising contacting a reinforcing agent with the tailings stream in step (a).

3. A process according to claim 1, further comprising contacting an accelerator with the tailings stream in step (a).

4. A process according to claim 1, wherein the gelling agent is selected from the group consisting of alkali metal silicates, polysilicate microgels, deionized silicate solutions having a molar ratio of Si:M of at least 2.6, wherein M is an alkali metal, colloidal silica, aluminum-modified colloidal silica, de-ionized colloidal silica, polysiloxane, siliconate, acrylamide, acrylate, polyol, phenoplast, aminoplast, vinyl ester-styrene, polyester-styrene, furfuryl alcohol-based furol polymer, epoxy, vulcanized oil, lignin, lignosulfonate, lignosulfite, montan wax, polyvinyl pyrrolidone, and combinations of two or more thereof.

5. A process according to claim 4, wherein the gelling agent is an alkali metal silicate.

6. A process according to claim 1, wherein the activator is selected from the group consisting of carbon dioxide, acids, bases, alkaline earth metal salts, aluminum salts, organic esters, aldehydes, dialdehydes, organic carbonates, organic phosphates, amides, peroxides, isocyanate, sodium aluminate, aluminum sulfate, and combinations thereof.

7. A process according to claim 6, wherein the activator is carbon dioxide or sulfuric acid.

8. A process according to claim 1, wherein the depositing is above the layer of the liquid.

9. A process according to claim 1, wherein the depositing is sub-surface of the layer to the liquid.

10. A process according to claim 1, wherein the gel is partially gelled prior to step (c).

11. A process according to claim 1, wherein the gel is fully gelled prior to step (c).

12. A process according to claim 1, wherein the gel is allowed to strengthen and solidify prior to step (c).

13. A process according to claim 1, further comprising partially or fully dewatering the gel prior to step (c).

14. A process according to claim 13, wherein dewatering occurs by air drying (evaporation), water run-off, compression, syneresis, exudation, freeze/thaw, sublimation, or any combination thereof.

15. A process according to claim 14, wherein dewatering occurs by evaporation.

16. A process according to claim 14, wherein dewatering occurs by water run-off.

17. A process according to claim 1, wherein the tailings stream is chemically thickened, mechanically thickened, or both, forming a partially dewatered tailings stream, prior to step (a).

18. A process according to claim 17, wherein the chemically thickening is by flocculation.

19. A process according to claim 17, wherein the mechanically thickening is by centrifuge.

20. A process according to claim 1, wherein the tailings stream is a mature fine tailings.

21. A process according to claim 1, wherein the tailings stream is a fresh tailings from a bitumen recovery process.

22. A process according to claim 1, further comprising depositing a layer of sand or other solids to the top of the deposited gel.

23. A process according to claim 1, further comprising removing the gel from the liquid and allowing the gel to partially or fully dewater.

24. A process for treating a tailings stream comprising water and solids beneath a liquid surface, comprising (a) contacting a gelling agent and an activator with the tailings stream beneath the liquid surface, (b) entrapping the solids within a gel produced from the gelling agent.

25. A process according to claim 24, further comprising contacting a reinforcing agent, an accelerator, or any of their combinations with the tailings stream in step (a).

26. A process according to claim 24, further comprising depositing a layer of sand or other solids to the top of the gel.

27. A process according to claim 24, further comprising removing the gel from the liquid and allowing the gel to partially or fully dewater.
